(19) United States
(12) Patent Application Publication
(10) Pub. No.: US 2026/0266960 A1
(43) Pub. Date: Sep. 10, 2026

(54) LIDAR CHANNEL ARRANGEMENT SYSTEM AND VEHICLE

(71) Applicant: TENSOR AI SINGAPORE PTE. LTD., SINGAPORE (SG)

(72) Inventors: Zhuo Li, Shenzhen (CN); Yizhou Shan, Shenzhen (CN); Longxin Chen, Shenzhen (CN); Tongda Yang, Shenzhen (CN)

(73) Assignee: TENSOR AI SINGAPORE PTE. LTD., SINGAPORE (SG)

(21) Appl. No.: 19/213,163

(22) Filed: May 20, 2025

(30) Foreign Application Priority Data
Mar. 7, 2025 (CN) 2025102761024

(51) Int. Cl. G01S 7/481; G01S 17/931

(52) U.S. Cl. CPC G01S 7/4815; G01S 17/931

(57) ABSTRACT

A LiDAR channel arrangement system for a vehicle, includes a LiDAR and a main control device. The LiDAR includes emitter plates, each emitter plate disposed emitters to emit laser beams, a cluster of adjacent laser beams forming a detection region of the LiDAR, and different groups of the emitters generates non-overlapping detection regions that are coplanar. The main control device including a grouping unit, configured to divide the plurality of emitters into emitter groups, to make a total detection region generated by the plurality of emitters divide into a reference region and a non-reference region, the reference region containing a reference line of the LiDAR while the non-reference region not containing the reference line; and a control unit, configured to control the LiDAR to activate the emitter plate so as to control emitters of one or more emitter groups to emit the laser beams.

This non-provisional patent application claims priority under 35 U.S.C. § 119 from Chinese Patent Application No. 202510276102.4 filed on Mar. 7, 2025, the entire content of which is incorporated herein by reference.

### TECHNICAL FIELD

The disclosure relates to the technical field of LiDAR, and particularly to a LiDAR channel arrangement system and a vehicle.

### BACKGROUND

A LiDAR is a system that detects a target's position and surface optical characteristics through laser beams, and is widely used in the field of vehicles. Existing laser beam arrangement designs are mainly designed according to equal angular spacing methods. However, such arrangement methods are affected by vehicle driving scenarios during driving, making it difficult to fully scan areas with high visual importance during vehicle driving through a single laser beam arrangement method.

### SUMMARY

The disclosure provides a LiDAR channel arrangement system and a vehicle, which enable different laser beam emission arrangements by activating different emitter plates with multiple arrangement modes.

In a first aspect, the disclosure provides a LiDAR channel arrangement system installed on a vehicle. The LiDAR channel arrangement system includes a LiDAR, including a plurality of emitter plates, each emitter plate disposed a plurality of emitters to emit laser beams, a cluster of adjacent laser beams forming a detection region of the LiDAR, and different groups of the emitters generates non-overlapping detection regions that are coplanar; and a main control device, communicated to the LiDAR, including a grouping unit, configured to divide the plurality of emitters into a plurality of emitter groups, to make a total detection region generated by the plurality of emitters divide into a reference region and a non-reference region, the reference region containing a reference line of the LiDAR while the non-reference region not containing the reference line; and a control unit, configured to control the LiDAR to activate the emitter plate so as to control emitters of one or more emitter groups to emit the laser beams.

In a second aspect, the disclosure provides a vehicle. The vehicle comprises a vehicle body and the aforementioned LiDAR channel arrangement system installed on the vehicle body.

The above LiDAR channel arrangement system and vehicle determine different laser beam emission arrangements of the LiDAR through the emitter plates, divide the emitters on the emitter plates into several emitter groups through the grouping unit of the main control device to partition different numbers of laser beams in different emitter groups, and control the LiDAR to activate the emitter plates through the control unit to control emitters of one or more emitter groups to emit laser beams, thereby realizing flexible laser beam emission arrangements based on vehicle scenarios and improving detection flexibility of the LiDAR.

### BRIEF DESCRIPTION OF THE DRAWINGS

To clearly illustrate technical solutions in the embodiments of the disclosure or the prior art, the drawings to be used in the description of the embodiments or the prior art will be briefly introduced below. It is apparent that the drawings described below are merely some embodiments of the disclosure, and those of ordinary skill in the art can obtain other drawings based on the structures shown in these drawings without creative efforts.

FIG. 1 is a schematic structural diagram of a LiDAR channel arrangement system in accordance with an embodiment.

FIG. 2 is a schematic diagram of a first implementation scenario of an emitter plate of a LiDAR in accordance with an embodiment.

FIG. 3 is a schematic diagram of a second implementation scenario of an emitter plate of a LiDAR in accordance with an embodiment.

FIG. 4 is a schematic diagram of a third implementation scenario of an emitter plate of a LiDAR in accordance with an embodiment.

FIG. 5 is a schematic diagram of a vehicle in accordance with an embodiment.

The realization of the objectives, functional features, and advantages of the disclosure will be further described below with reference to the embodiments and the drawings.

### DETAILED DESCRIPTION OF THE EMBODIMENTS

In order to make the purpose, technical solution, and advantages of disclosure clearer and clearer, the following will provide further detailed explanations of disclosure in conjunction with the accompanying drawings and embodiments. It should be understood that the specific embodiments described here are only intended to explain the present application and are not intended to limit the present application. Based on the embodiments in disclosure, all other embodiments obtained by ordinary technical personnel in this field without creative labor fall within the scope of protection of disclosure.

The terms “first,” “second,” “third,” “fourth,” etc. (if present) in the specification, claims, and accompanying drawings of the present application are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is understood that the descriptions involving “first,” “second,” etc., in the present application are solely for descriptive purposes and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the present application.

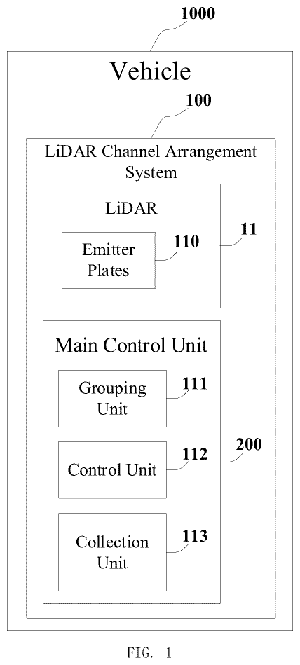

Referring to FIG. 1, a schematic structural diagram of a LiDAR channel arrangement system in accordance with an embodiment is illustrated. The disclosure provides a LiDAR channel arrangement system 100. A LiDAR 11 is installed on a vehicle 1000. The LiDAR channel arrangement system 100 can controllably activate different emitter plates inside the LiDAR 11 to adopt laser beams with different arrangement modes to detect targets outside the vehicle 1000 based on driving scenarios of the vehicle 1000, so as to adapt to detection in different scenarios of the vehicle 1000. Specifically features of the LiDAR 11 will be described below.

As shown in FIG. 1, the LiDAR channel arrangement system 100 includes the LiDAR 11, and a main control device 200. The LiDAR 11 is located on a top of the vehicle 1000. The LiDAR 11 includes a plurality of emitter plates 110. The emitter plate 110 is disposed a plurality of emitters (not shown) for emitting laser beams 10. A quantity of the emitters on each emitter plate 110 may be equal or unequal. A cluster of adjacent laser beams 10 forms a detection region of the LiDAR 11. Adjacent detection regions are spaced at certain spacing in a direction perpendicular to a reference line 20 of the LiDAR 11. Different spacing sizes affect the detection range and detection accuracy of the corresponding laser beams 10 of the LiDAR 11. Detection regions formed by different emitters are located on the same plane without overlapping. Optionally, the emitter plate 110 is parallel to the reference line 20. The detection regions formed by the laser beams 10 emitted from respective emitters on the emitter plate 110 are arranged in a column perpendicular to the reference line 20, and the detection regions formed by the laser beams 110 emitted from respective emitters have certain intervals in the arrangement direction.

In this embodiment, different detection regions corresponding to different emitters are used to achieve adaptation to multiple driving scenarios. Specifically, the main control device 200 is communicatively connected to the LiDAR 11 and is used to control the LiDAR 11 to emit laser beams 10 with different arrangement modes. The main control device 200 includes a grouping unit 111, and a control unit 112. The main control device 200 maybe a IC integrate the grouping unit 111 and the control unit 112. The grouping unit 111 is configured to divide the plurality of emitters on the emitter plate 110 into several emitter groups, thereby partitioning the total detection region 40 formed by the laser beams 10 emitted from the emitters of the plurality of emitter groups into a reference region containing the reference line 20 of the LiDAR 11 and a non-reference region not containing the reference line 20. In this embodiment, the reference region and the non-reference region respectively correspond to areas with higher and lower observation frequencies of the LiDAR 11 installed on the vehicle 1000. To enable the LiDAR 11 to more clearly observe areas that need to be observed by the vehicle 1000, the number of laser beams 10 in the reference region is greater than the number of laser beams 10 in the non-reference region. The total detection region 40 has a first boundary 1 and a second boundary 2. The reference line 20 is located between the first boundary 1 and the second boundary 2. The total detection region 40 will be elaborated below.

In this embodiment, the main control device 200 further includes collection unit 113. The collection unit 113 is configured to collect driving information of the vehicle 1000. The driving information includes one or more of terrain information, environmental information, and weather information of a current scene of the vehicle 1000, as well as model information of the vehicle 1000. The collection unit 113 maybe a communication interface device. The model information is used to determine the position of the LiDAR 11 on the vehicle 1000. The grouping unit 111 divides the plurality of emitters on the emitter plate 110 into several emitter groups based on the scene information. Specifically, when the vehicle 1000 observes targets outside the vehicle through the LiDAR 11, the vehicle 1000 has certain observation requirements for part or all of the field of view of the LiDAR 11 based on driving needs. The grouping unit 111 obtains spacing between detection regions in the reference region based on the scene information and a preset observation distance. The preset observation distance is a maximum observation distance of the LiDAR 11. The smaller the spacing, the smaller the corresponding resolution of the LiDAR 11, the higher the accuracy, and the smaller the corresponding observation range. After obtaining the minimum resolution, the grouping unit 111 partitions spacing between other detection regions in the total detection region 40 based on the spacing between detection regions in the reference region.

For example, during driving of the vehicle 1000, the front and lower sides of the vehicle 1000 need to focus on observing targets outside the vehicle to ensure driving safety. Therefore, the front and lower fields of view of the LiDAR 11 are observation requirements of the vehicle 1000. The upper field of view of the LiDAR 11 will be slightly less important because it is above the vehicle body. Taking terrain information as an example, when the vehicle 1000 drives continuously on different terrains, such as uphill, downhill, and turning on continuous steep slopes, the field of view of the LiDAR 11 will be adjusted accordingly based on terrain changes, thereby correspondingly adjusting the division of several emitter groups.

The control unit 112 is configured to control the LiDAR 11 to activate the emitter plate 110 so as to control emitters of one or more emitter groups to emit the laser beams 10. The following will elaborate specific features of the detection regions corresponding to the laser beams 10 emitted from the emitters on the emitter plate 110.

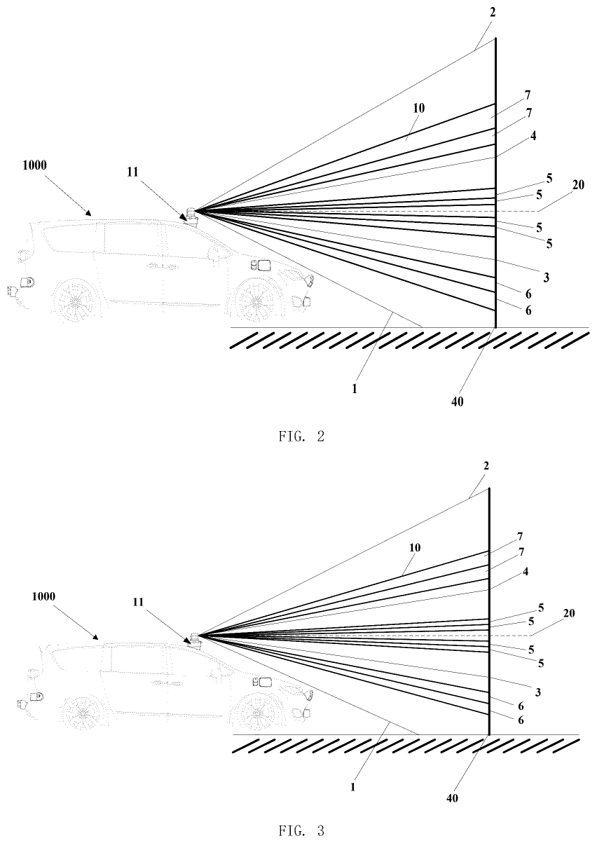

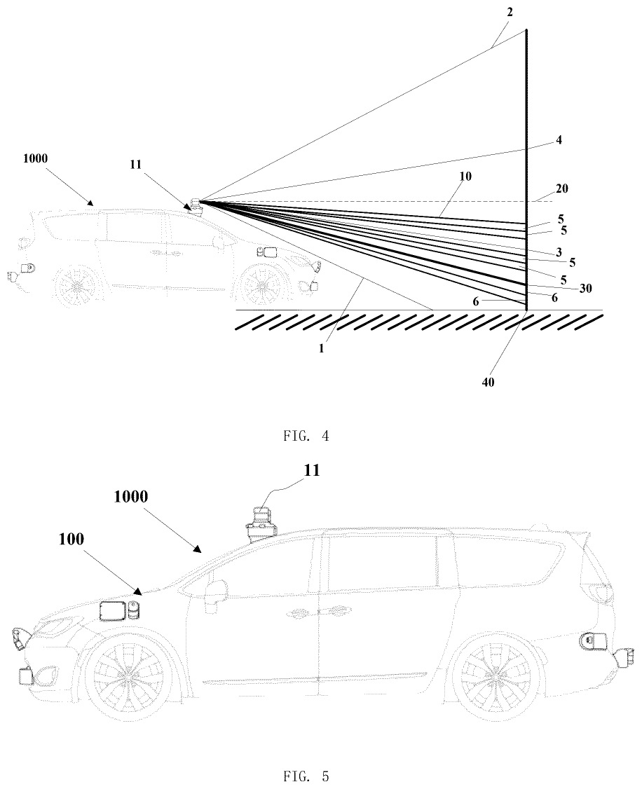

Referring to FIGS. 2-4, which illustrate implementation scenarios of different emitter plates of the LiDAR.

In this embodiment, one feature of the emitter plate 110 is: along a direction of the total detection region 40 perpendicular to the reference line 20, spacing 5 between the detection regions gradually increases from the reference line 20 towards the first boundary 1 and the second boundary 2 respectively. Therefore, a corresponding feature of the emitter plate 110 is: spacing between adjacent emitters in several emitter groups obtained through division gradually increases from emitter groups containing the reference line 20 towards the first boundary 1 and the second boundary 2 respectively, so that the total detection region 40 as a whole presents a “sparse,” “dense,” “sparse” arrangement trend, improving the observation range of edges of the LiDAR 11.

In this embodiment, another feature of the emitter plate 110 is: the total detection region 40 has a first boundary 1 and a second boundary 2. The reference line 20 is located between the first boundary 1 and the second boundary 2. The reference region has a third boundary 3 and a fourth boundary 4. The third boundary 3 is located between the first boundary 1 and the reference line 20. The fourth boundary 4 is located between the second boundary 2 and the reference line 20. Spacing between detection regions in the reference region is smaller than or equal to spacing between detection regions in the non-reference region. At the same time, the non-reference region includes a first sub-region located between the first boundary 1 and the third boundary 3, and a second sub-region located between the second boundary 2 and the fourth boundary 4. Spacing 6 between detection regions in the first sub-region may be equal or unequal. Spacing 7 between detection regions in the second sub-region may be equal or unequal, so that the total detection region 40 as a whole presents a “sparse,” “dense,” “sparse” arrangement trend, improving the observation range of edges of the LiDAR 11.

In this embodiment, the first sub-region is provided with a gradient boundary 30. The gradient boundary 30 is located between the third boundary 3 and the first boundary 1. Spacing between detection regions in the first sub-region gradually increases from the gradient boundary 30 to the first boundary 1, and spacing between detection regions from the gradient boundary 30 to the third boundary 3 is equal to spacing between detection regions in the reference region, so as to improve observation accuracy of the LiDAR 11 in the first sub-region while also improving the observation range of edges of the LiDAR 11 in the first sub-region. Spacing between detection regions in the second sub-region gradually increases from the fourth boundary 4 to the second boundary 2, so as to further improve the observation range of edges in the second sub-region.

It can be understood that the arrangement modes exemplified in the above embodiments can be applied to the emitter plate 110, and the arrangement order of emitters in the emitter plate 110 can be adjusted according to detection requirements. The arrangement modes exemplified in the above embodiments are merely examples of multiple arrangement modes, and are not limitations on arrangement modes, which will not be elaborated herein.

In the above embodiments, adjusting the detection accuracy and detection range of the LiDAR 11 when detecting targets outside the vehicle through different emitters in the emitter plate 110 is described. In the disclosure, the control unit 112 is further configured to control intensity of the laser beams 10 emitted from emitters of one or more emitter groups, as well as emission sequence of the one or more emitter groups. For example, when the scene information of the vehicle 1000 is weather information, and the weather information is haze, the vehicle 1000 can adjust the observation process of the LiDAR 11 by adjusting intensity of the laser beams 10 emitted from emitters of one or more emitter groups on the emitter plate 110 through the control unit 112. At the same time, the vehicle 1000 can also adjust emission sequence of emitters of one or more emitter groups through the control unit 112.

Referring to FIG. 5, a schematic diagram of a vehicle in accordance with an embodiment. The disclosure also provides a vehicle 1000. The vehicle 1000 is equipped with a LiDAR 11. The vehicle 1000 comprises a vehicle body and the LiDAR channel arrangement system 100 installed on the vehicle body. The LiDAR 11 is installed on a top of the vehicle body, so that the LiDAR 11 is located on a top of the vehicle 1000. The LiDAR channel arrangement system 100 has been elaborated above, and will not be elaborated herein.

In the above embodiments, different laser beam emission arrangements of the LiDAR are determined by providing the emitter plate, emitters on the emitter plate are divided into several emitter groups by the grouping unit of the main control device to partition different numbers of laser beams in different emitter groups, and the LiDAR is controlled to activate the emitter plate by the control unit to control emitters of one or more emitter groups to emit laser beams, thereby realizing flexible laser beam emission arrangements based on vehicle scenarios and improving detection flexibility of the LiDAR.

It is apparent to those skilled in the art that various modifications and variations can be made to the disclosure without departing from the spirit and scope thereof. Therefore, if these modifications and variations of the disclosure fall within the scope of the claims and their equivalent technologies, the disclosure also intends to include these modifications and variations.

The above listed are merely preferred embodiments of the disclosure, and of course cannot be used to limit the scope of the claims of the disclosure. Therefore, equivalent variations made according to the claims of the disclosure still fall within the scope covered by the disclosure.

1. A LiDAR channel arrangement system for a vehicle, comprising:
a LiDAR, including a plurality of emitter plates, each emitter plate disposed a plurality of emitters to emit laser beams, a cluster of adjacent laser beams forming a detection region of the LiDAR, and different groups of the emitters generates non-overlapping detection regions that are coplanar; and
a main control device, communicated to the LiDAR, comprising:
a grouping unit, configured to divide the plurality of emitters into a plurality of emitter groups, to make a total detection region generated by the plurality of emitters divide into a reference region and a non-reference region, the reference region containing a reference line of the LiDAR while the non-reference region not containing the reference line; and
a control unit, configured to control the LiDAR to activate the emitter plate so as to control emitters of one or more emitter groups to emit the laser beams.

2. The LiDAR channel arrangement system according to claim 1, wherein the main control device further comprises collection unit configured to collect driving information of the vehicle, the driving information includes one or more of terrain information, environmental information, and weather information of a current scene of the vehicle, as well as model information of the vehicle; and the grouping unit divides the plurality of emitters into the plurality of emitter groups based on the scene information.

3. The LiDAR channel arrangement system according to claim 1, wherein the LiDAR is located on a top of the vehicle.

4. The LiDAR channel arrangement system according to claim 1, wherein each emitter plate is parallel to the reference line; and the detection regions respectively formed by the laser beams emitted from each emitter are arranged in a column perpendicular to the reference line.

5. The LiDAR channel arrangement system according to any of claims 1, wherein the total detection region has a first boundary, and a second boundary, the reference line is located between the first boundary and the second boundary.

6. The LiDAR channel arrangement system according to claim 5, wherein along a direction of the total detection region perpendicular to the reference line, spacing between the detection regions gradually increases from the reference line towards the first boundary and the second boundary respectively.

7. The LiDAR channel arrangement system according to claims 1, wherein the reference region has a third boundary and a fourth boundary, the third boundary is located between the first boundary and the reference line, and the fourth boundary is located between the second boundary and the reference line; and spacing between detection regions in the reference region is smaller than or equal to spacing between detection regions in the non-reference region.

8. The LiDAR channel arrangement system according to claim 7, wherein the non-reference region includes a first sub-region located between the first boundary and the third boundary, and a second sub-region located between the second boundary and the fourth boundary; the first sub-region includes a gradient boundary located between the third boundary and the first boundary, and spacing between detection regions in the first sub-region gradually increases from the gradient boundary to the first boundary, ; spacing between detection regions from the gradient boundary to the third boundary is equal to spacing between detection regions in the reference region; and spacing between detection regions in the second sub-region gradually increases from the fourth boundary to the second boundary.

9. The LiDAR channel arrangement system according to claim 1, wherein the control unit is further configured to control intensity of the laser beams emitted from emitters of one or more emitter groups, as well as emission sequence of the one or more emitter groups.

10. A LiDAR, comprising:
emitter plates, each emitter plate having a plurality of emitters to emit laser beams, wherein a group of adjacent laser beams forms a detection region of the LiDAR, and detection regions formed by different emitters are located on the same plane without overlapping; and
a grouping unit, configured to divide the plurality of emitters into several emitter groups, thereby partitioning the total detection region formed by the laser beams emitted from the emitters of the plurality of emitter groups into a reference region containing a reference line of the LiDAR and a non-reference region not containing the reference line; and
a control unit, configured to control the LiDAR to activate the emitter plate so as to control emitters of one or more emitter groups to emit the laser beams.

11. The LiDAR according to claim 10, wherein the LiDAR is mounted on a vehicle, the LiDAR further comprises collection unit configured to collect driving information of the vehicle, the driving information includes one or more of terrain information, environmental information, and weather information of a current scene of the vehicle, as well as model information of the vehicle; and the grouping unit divides the plurality of emitters into the plurality of emitter groups based on the scene information.

12. The LiDAR according to claim 11, wherein the LiDAR is located on a top of the vehicle.

13. The LiDAR according to claim 10, wherein each emitter plate is parallel to the reference line; and the detection regions respectively formed by the laser beams emitted from each emitter are arranged in a column perpendicular to the reference line.

14. The LiDAR according to any of claims 10, wherein the total detection region has a first boundary, and a second boundary, the reference line is located between the first boundary and the second boundary.

15. The LiDAR according to claim 14, wherein along a direction of the total detection region perpendicular to the reference line, spacing between the detection regions gradually increases from the reference line towards the first boundary and the second boundary respectively.

16. The LiDAR according to claims 10, wherein the reference region has a third boundary and a fourth boundary, the third boundary is located between the first boundary and the reference line, and the fourth boundary is located between the second boundary and the reference line; and spacing between detection regions in the reference region is smaller than or equal to spacing between detection regions in the non-reference region.

17. The LiDAR according to claim 16, wherein the non-reference region includes a first sub-region located between the first boundary and the third boundary, and a second sub-region located between the second boundary and the fourth boundary; the first sub-region includes a gradient boundary located between the third boundary and the first boundary, and spacing between detection regions in the first sub-region gradually increases from the gradient boundary to the first boundary, ; spacing between detection regions from the gradient boundary to the third boundary is equal to spacing between detection regions in the reference region; and spacing between detection regions in the second sub-region gradually increases from the fourth boundary to the second boundary.

18. The LiDAR according to claim 10, wherein the control unit is further configured to control intensity of the laser beams emitted from emitters of one or more emitter groups, as well as emission sequence of the one or more emitter groups.

19. A vehicle, comprising:
a vehicle body; and
a LiDAR channel arrangement system disposed on the vehicle body, the LiDAR channel arrangement system comprising:
a LiDAR, including a plurality of emitter plates, each emitter plate disposed a plurality of emitters to emit laser beams, a cluster of adjacent laser beams forming a detection region of the LiDAR, and different groups of the emitters generates non-overlapping detection regions that are coplanar; and
a main control device, communicated to the LiDAR, comprising:
a grouping unit, configured to divide the plurality of emitters into a plurality of emitter groups, to make a total detection region generated by the plurality of emitters divide into a reference region and a non-reference region, the reference region containing a reference line of the LiDAR while the non-reference region not containing the reference line; and
a control unit, configured to control the LiDAR to activate the emitter plate so as to control emitters of one or more emitter groups to emit the laser beams.

20. The vehicle according to claim 19, wherein the main control device further comprises collection unit configured to collect driving information of the vehicle, the driving information includes one or more of terrain information, environmental information, and weather information of a current scene of the vehicle, as well as model information of the vehicle; and the grouping unit divides the plurality of emitters into the plurality of emitter groups based on the scene information.
